(19) United States
(12) Patent Application Publication
(10) Pub. No.: US 2020/0411941 A1
(43) Pub. Date: Dec. 31, 2020

(54) TRANSMISSION LINE MODULE AND MOBILE TERMINAL

(71) Applicant: AAC Technologies Pte. Ltd., Singapore City (SG)

(72) Inventors: Shijie Liu, Shenzhen (CN); Yongli Chen, Shenzhen (CN)

(21) Appl. No.: 16/994,685

(22) Filed: Aug. 17, 2020

Related U.S. Application Data
(63) Continuation of application No. PCT/CN2019/094071, filed on Jun. 30, 2019.

(51) Int. Cl. H01P 3/08; H01P 5/08; H01P 1/02; H01R 12/77

(52) U.S. Cl. CPC H01P 3/08; H01P 5/08; H01R 2201/02; H01R 12/77; H01P 1/02

(57) ABSTRACT

The present disclosure provides a transmission line module, including a transmission line and a first connection terminal connected to one end of the transmission line and configured to connect to a connector. The transmission line module also includes at least two of the following connection terminals connected to the transmission line: an antenna connection terminal configured to connect to an antenna, an external connection terminal configured to connect to an external device, and a second connection terminal configured to connect to another connector. The transmission line module integrates at least two connection modes and can connect antennas, external devices and other connectors, replacing the conventional connection manner of separate connection. In this way, one module can solve the connection of all lower antennas and can also avoid interference with other signal lines. In addition, it does not occupy any space of the main board.

### TECHNICAL FIELD

The present disclosure relates to the technical field of antenna, in particular to a transmission line module.

### BACKGROUND

In the existing technologies, a lower antenna is usually connected to the antenna through a coaxial line. For multiple antennas (main antenna/sub-6G/LTE MIMO/sub-6G), multiple coaxial lines are needed and higher requirements for space are proposed. However, the connect spring, ground feed point and matching circuit of the existing antennas take up a large space. Multiple coaxial lines take up a lot of space because the conventional coaxial lines are thick. Some places are out of reach for the conventional small board as the space is small.

Therefore, it is necessary to provide a new transmission line module to solve the above problems.

### SUMMARY

The present disclosure intends to provide a transmission line module that integrates at least two connection modes.

The technical solution of the present disclosure is as follows.

A transmission line module is provided, including a transmission line and a first connection terminal connected to one end of the transmission line and configured to connect to a connector. The transmission line module further includes at least two of the following connection terminals connected to the transmission line: an antenna connection terminal configured to connect to an antenna, an external connection terminal configured to connect to an external device, and a second connection terminal configured to connect to another connector.

As an improvement, the transmission line module includes one first connection terminal, one antenna connection terminal, one external connection terminal and one second connection terminal.

As an improvement, the transmission line module includes a main line and a branch line connected to the main line, the first connection terminal and the external connection terminal are respectively connected to the both ends of the main line, the antenna connection terminal is connected to a side of the main line facing away from the branch line, and the second connection terminal is connected to an end of the branch line away from the main line.

As an improvement, the main line has a first side edge and a second side edge that are disposed separately from and opposite to each other, the branch line is connected to the first side edge, the antenna connection terminal is connected to the second side edge, and an orthographic projection of a connection portion where the antenna connection terminal connects the main line on the first side edge does not overlap with an orthographic projection of a connection portion where the branch line connects the main line on the first side edge.

As an improvement, the branch line is vertically connected to the first side edge.

As an improvement, the main line has a first end portion and a second end portion disposed opposite to each other, the first connection terminal is connected to the first end portion, the external connection terminal is connected to the second end portion, and the connection portion where the branch line connects the main line and the connection portion where the antenna connection terminal connects the main line are located close to the second end portion.

As an improvement, the main line includes a first section, a bending portion and a second section, the first section is connected to the second section through the bending portion, the first section has the first end portion, the second section has the second end portion, the bending portion is inclined to the first section, and extends, from a connection portion where the bending portion connects to the first section, inclinedly in a direction away from the branch line.

As an improvement, the main line has a top surface and a bottom surface opposite to the top surface, the first connection terminal is connected to the top surface of the main line, and an end of the first section disposed away from the bending portion is bent from the bottom surface toward the top surface to form the first end portion.

As an improvement, the connection portion where the branch line connects the main line is located between the second end portion and the connection portion where the antenna connection terminal connects the main line.

As an improvement, the branch line has a third end portion disposed away from the main line, an end of the branch line disposed away from the main line is bent from the top surface of the main line toward the bottom surface of the main line to form the third end portion, and the second connection terminal is connected to the third end portion.

The beneficial effects of the present disclosure are as follows.

Compared with the existing technology, the transmission line module of the present disclosure has a first connection terminal configured to connect to a connector and at least two of the following connection terminals: an antenna connection terminal configured to connect to an antenna, an external connection terminal configured to connect to an external device, and a second connection terminal configured to connect to another connector. The transmission line module integrates at least two connection modes and can connect antennas, external devices and other connectors, replacing the conventional connection manner of separate connection. In this way, one module can solve the connection of all lower antennas and can also avoid interference with other signal lines. In addition, it does not occupy any space of the main board.

### BRIEF DESCRIPTION OF THE DRAWINGS

FIG. 1 is a three-dimensional structural schematic diagram of a transmission line module provided by embodiments of the present disclosure;

FIG. 2 is an enlarged view of A in FIG. 1;

FIG. 3 is an enlarged view of B in FIG. 1;

FIG. 4 is a schematic diagram of a top view of a transmission line module provided by embodiments of the present disclosure;

FIG. 5 is a three-dimensional structural schematic diagram of a mobile terminal provided by embodiments of the present disclosure.

### DETAILED DESCRIPTION

In order to make the purpose, the technical solution and the advantages of the present disclosure clearer, the present disclosure will be explained below in detail with reference to the accompanying drawings and embodiments. It should be understood that the specific embodiments described here are merely used to explain the present disclosure but not to impose a limitation to the present disclosure. Based on the embodiments of the present disclosure, all other embodiments obtained by those of ordinary skill in the art without making inventive efforts fall within the protection scope of the present disclosure.

The terms “first”, “second”, “third”, “fourth”, etc. (if any) in the description and claims of the present disclosure and the above drawings are used to distinguish similar objects without being used to describe a specific order or sequence. It should be understood that the data used in this way may be interchanged under appropriate circumstances so that the embodiments described herein may be implemented in an order other than what is illustrated or described herein. In addition, the terms “including” and “having” and any variations thereof are intended to cover non-exclusive inclusions, for example, a series of processes, methods, systems, products or devices that includes a series of steps or units need not be limited to those steps or units clearly listed but may include other steps or units that are not explicitly listed or inherent to these processes, methods, products or devices.

It should be noted that the descriptions related to “first”, “second”, etc. in the present disclosure are only for descriptive purposes, and cannot be understood as indicating or implying their relative importance or implicitly indicating the number of technical features indicated. Thus, the features defined as “first” and “second” may include at least one of the features either explicitly or implicitly. In addition, the technical solutions between the various embodiments can be combined with each other, but they must be based on the premise that those skilled in the art can achieve. When the combination of technical solutions conflicts with each other or cannot be realized, it should be considered that the combination of such technical solutions does not exist and does not fall within the protection scope claimed by the present disclosure.

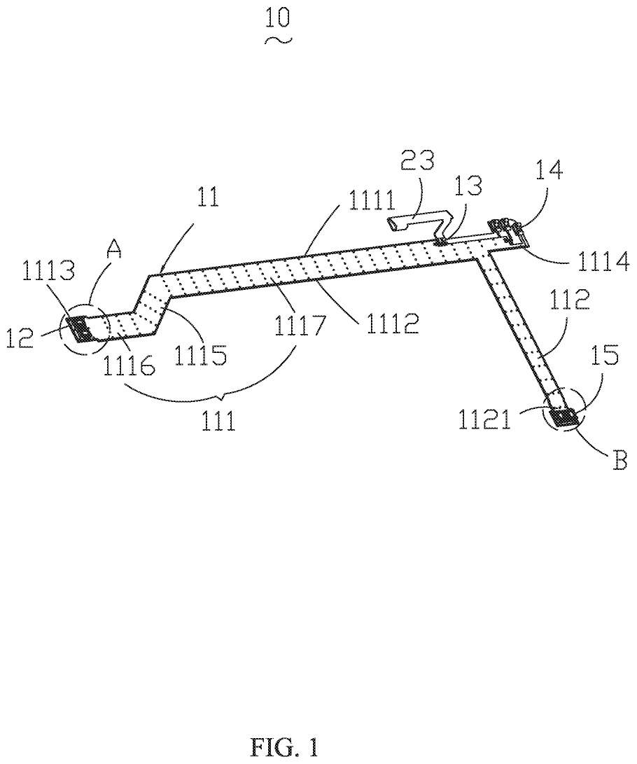

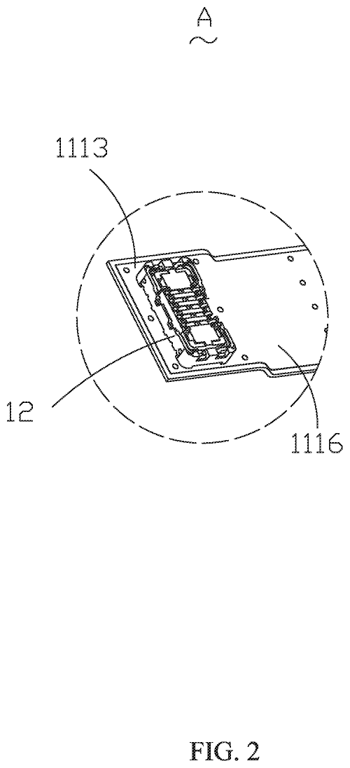

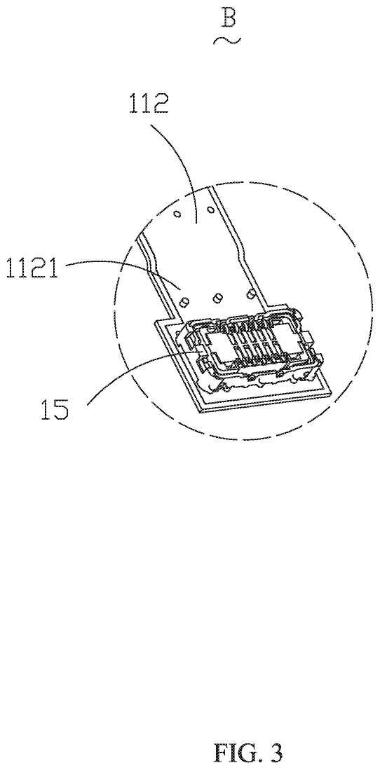

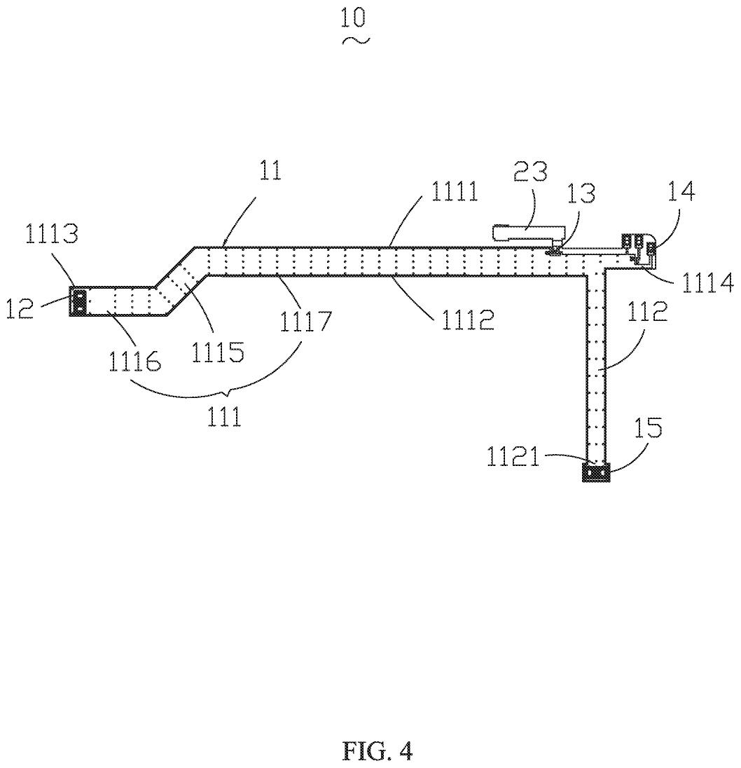

Referring to FIGS. 1-4 together, the transmission line module 10 of this embodiment is used to process transmissible signals, including a transmission line 11 and a first connection terminal 12 connected to one end of the transmission line 11 and configured to connect to a connector. The transmission line module 10 further includes at least two of the following connection terminals connected to the transmission line 11: an antenna connection terminal 13 configured to connect to an antenna, an external connection terminal 14 configured to connect to an external device, and a second connection terminal 15 configured to connect to another connector. The first connection terminal 12 is provided with a circuit and is electrically connected to the antenna connection terminal 13, the external connection terminal 14 and the second connection terminal 15, respectively. The external terminal 14 is configured to connect to the external device through an LDS (Laser Direct Structuring) antenna. As shown in FIG. 1, the antenna connection terminal 13 is connected to the antenna 23.

The number and types of the antenna connection terminal 13, the external connection terminal 14 and the second connection terminal 15 may be freely combined as needed on the basis that the transmission line module 10 has the first connection terminal 12.

In this embodiment, the transmission line module 10 includes the first connection terminal 12, the antenna connection terminal 13, the external connection terminal 14 and the second connection terminal 15. The transmission line module 10 integrates three connection modes and may connect the antenna, external device and other connectors, replacing the conventional connection manner of separate connection. In this way, one module can solve the connection of all lower antennas and can also avoid interference with other signal lines. In addition, it does not occupy any space of the mainboard.

In other embodiments, the transmission line module 10 includes the first connection terminal 12, the antenna connection terminal 13 and the second connection terminal 15. The transmission line module 10 may also have other combinations, which will not be exemplified here.

Referring to FIGS. 1-4 together, the transmission line 11 includes a main line 111 and a branch line 112 connected to the main line 111. The main line 111 has a first side edge 1111 and a second side edge 1112 that are disposed separately from and opposite to each other, and also has a first end portion 1113 and a second end portion 1114 disposed opposite to each other. The first connection terminal 12 is connected to the first end portion 1113, the external connection terminal 14 is connected to the second end portion 1114, and the antenna connection terminal 13 is connected to the second side edge 1112. The branch line 112 is vertically connected to the first side edge 1111. A connection portion where the branch line 112 connects to the main line 111 is located between the second end portion 1114 and a connection portion where the antenna connection terminal 13 connects the main line 111. The orthographic projection of the connection portion where the branch line 112 connects the main line 111 on the first side edge 1111 does not overlap with the orthographic projection of the connection portion where the antenna connection terminal 13 connects the main line 111 on the first side edge 1111. The branch line 112 has a third end portion 1121 disposed away from the main line 111 and the second connection terminal 15 is connected to the third end portion 1121.

Optionally, for convenience of installation, and in order to facilitate better connection of the antenna connection terminal 13 to the antenna and connection of the external connection terminal 14 to the external device, the main line 111 forms a bending portion 1115 near the first end portion 1113. The bending portion 1115 divides the main line 111 into two sections, namely a first section 1116 having a first end portion 1113 and a second section 1117 having a second end portion 1114. The first section 1116 and the second section 1117 are connected by the bending portion 1115. The bending portion 1115 is inclined to the first section 1116, and extends, from a connection portion where it connects to the first section 1116, inclinedly in a direction away from the branch line 112.

Optionally, in order to facilitate better connection of the first connection terminal 12 to the connector, the main line 111 has a top surface and a bottom surface opposite to the top surface. The first connection terminal 12 is connected to the top surface of the main line 111. An end of the first section 1116 disposed away from the bending portion 1115 is bent from the bottom surface toward the top surface to form the first end portion 1113, and such design may also perform a positioning function.

Optionally, in order to facilitate better connection of the second connection terminal 15 to the connector, an end of the branch line 112 disposed away from the main line 111 is bent from the top surface of the main line 111 toward the bottom surface of the main line 111 to form the third end portion 1121, and such design may also perform a positioning function.

In the application of the transmission line module 10, more than two transmission line modules 10 may also be used in connection. When more than two transmission line modules 10 are used in connection, the first connection terminal 12 of a second transmission line module 10 is connected to the second connection terminal 15 of a first transmission line module 10, and so on.

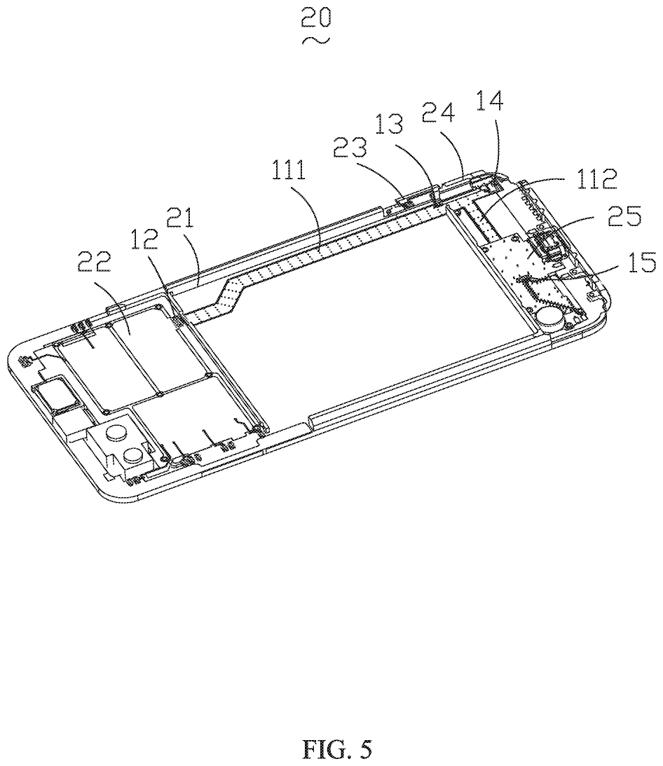

Referring to FIG. 5, the transmission line module 10 is applied to a mobile terminal 20. The mobile terminal 20 includes a transmission line module 10, a housing 21, a main board 22, an antenna 23, an LDS antenna 24, and upper and lower PCB boards 25. The transmission line module 10, the main board 22, the antenna 23, the LDS antenna 24 and the upper and lower PCB boards 25 are disposed within the housing 21. The first connection terminal 12 of the transmission line module 10 is connected to the main board 22, the antenna connection terminal 13 is connected to the antenna 23, the external connection terminal 14 is connected to the external device through the LDS antenna 24, and the second connection terminal 15 is connected to the upper and lower PCB boards 25.

The above-described are merely embodiments of the present disclosure. It should be noted that those of ordinary skill in the art can make improvements without departing from the inventive concept of the present disclosure, such improvements, however, fall within the protection scope of the present disclosure.

What is claimed is:

1. A transmission line module, comprising a transmission line and a first connection terminal connected to one end of the transmission line and configured to connect to a connector, the transmission line module further comprising at least two of the following connection terminals connected to the transmission line: an antenna connection terminal configured to connect to an antenna, an external connection terminal configured to connect to an external device, and a second connection terminal configured to connect to another connector.

2. The transmission line module according to claim 1, comprising one first connection terminal, one antenna connection terminal, one external connection terminal and one second connection terminal.

3. The transmission line module according to claim 2, further comprising a main line and a branch line connected to the main line, wherein the first connection terminal and the external connection terminal are respectively connected to both ends of the main line, the antenna connection terminal is connected to a side of the main line facing away from the branch line, and the second connection terminal is connected to an end of the branch line disposed away from the main line.

4. The transmission line module according to claim 3, wherein the main line has a first side edge and a second side edge that are disposed separately from and opposite to each other, the branch line is connected to the first side edge, the antenna connection terminal is connected to the second side edge, and an orthographic projection of a connection portion where the antenna connection terminal connects the main line on the first side edge does not overlap with an orthographic projection of a connection portion where the branch line connects the main line on the first side edge.

5. The transmission line module according to claim 4, wherein the branch line is vertically connected to the first side edge.

6. The transmission line module according to claim 3, wherein the main line has a first end portion and a second end portion disposed opposite to each other, the first connection terminal is connected to the first end portion, the external connection terminal is connected to the second end portion, and the connection portion where the branch line connects the main line and the connection portion where the antenna connection terminal connects the main line are located close to the second end portion.

7. The transmission line module according to claim 6, wherein the main line comprises a first section, a bending portion and a second section, the first section is connected to the second section through the bending portion, the first section has the first end portion, the second section has the second end portion, the bending portion is inclined to the first section, and extends, from a connection portion where the bending portion connects to the first section, inclinedly in a direction away from the branch line.

8. The transmission line module according to claim 7, wherein the main line has a top surface and a bottom surface opposite to the top surface, the first connection terminal is connected to the top surface of the main line, and an end of the first section disposed away from the bending portion is bent from the bottom surface toward the top surface to form the first end portion.

9. The transmission line module according to claim 6, wherein the connection portion where the branch line connects the main line is located between the second end portion and the connection portion where the antenna connection terminal connects the main line.

10. The transmission line module according to claim 6, wherein the branch line has a third end portion disposed away from the main line, an end of the branch line disposed away from the main line is bent from the top surface of the main line toward the bottom surface of the main line to form the third end portion, and the second connection terminal is connected to the third end portion.
